(19) United States
(12) Patent Application Publication
(10) Pub. No.: US 2006/0001574 A1
(43) Pub. Date: Jan. 5, 2006

(54) Wideband Patch Antenna

(75) Inventor: Argy Petros, Lake Worth, FL (US)

Correspondence Address: THINK WIRELESS, INC., 6208 GRAND CYPRESS CIRCLE, LAKE WORTH, FL, 33463, US

(73) Assignee: THINK WIRELESS, INC., Lake Worth, FL (US)

(21) Appl. No.: 10/710,359

(22) Filed: Jul. 3, 2004

(51) Int. Cl. H01Q 1/24

(52) U.S. Cl. 343/702

(57) ABSTRACT

A wideband patch antenna is presented that comprises a patch which may be of pure metallic form or may be etched on a dielectric, that may be rectangular, elliptical, triangular, or any other geometric shape. The patch is disposed a distance above a ground plane and is driven by a helix-shaped or meandering probe disposed between the patch and the ground plane. The probe is normal to the ground plane. In addition, a plurality of such patch antennas may be combined to form antenna arrays or dual-band antenna structures.

### CROSS REFERENCE TO RELATED APPLICATIONS

### BACKGROUND OF INVENTION

Microstrip patch antennas are very popular for a wide variety of applications. They have several advantages such as low profile, low cost, simple fabrication and light weight that make them very suitable in fixed and mobile communication systems. A typical microstrip patch antenna comprises a patch above a ground plane and separated from the ground plane by a dielectric. A typical patch is fed by means of a coaxial feed, where the center conductor pin is physically connected to the patch. One drawback with such microstrip patch antennas is that they have a relatively narrow bandwidth and thus, are not generally suitable for applications requiring broad bandwidth. The bandwidth can be increased by increasing the substrate thickness and decreasing the substrate permittivity. Relatively large bandwidth is obtained by suspending the patch in air and increasing the antenna thickness: distance from patch to ground plane. However, the increase in thickness increases the coaxial probe inductance due to increased probe length, thus, limiting the antenna bandwidth. Several methods have been disclosed that reduce or compensate for this additional probe inductance while increasing the bandwidth of relatively thick microstrip patch antennas. These methods are described below.

Method 1: (Sabbin A. “A new broadband stacked two-layer microstrip antenna”, IEEE AP-S Int. Sym. Digest, 1983, 63-66) and (Lee, R. Q., Lee, K. F., Bobinchak, J. “Two-layer electromagnetically coupled rectangular patch antenna”, Antennas and Propagation Society International Symposium, 1988, AP-S. Digest, pp 948-951). A second parasitic patch on top of the driven patch electromagnetically coupled to the driven patch. The use of a parasitic patch on top or next to the driven patch increases the overall thickness and volume of the antenna, and cost.

Method 2: (Fong K. S., Pues H. F., Withers M. J. “Wideband multiple layer coaxial fed microstrip antenna element”, Electron Lett, 1985, 21, pp 497-499.) This method utilizes a capacitively coupled feed where a conductive disk, etched on a substrate, is attached to the top section of the feed and spaced a small distance below the patch. The capacitively coupled feed, although neutralizing the extra probe inductance, is a high-cost complex structure and requires high precision, thus increasing cost.

Method 3: (Pozar D. “A reciprocity method of analysis for printed slot and slot-coupled microstrip antennas”, IEEE Transactions on Antennas and Propagation, Vol. 34, 1986, Pp 1439-1446) and (Pozar D. M., Targonski, S. D. “Improved coupling for aperture coupled microstrip antennas”, Electronics Letters, 27, 13, 1991, pp 1129-1131). This approach utilizes aperture coupling using a slot and a microstrip line for feeding the patch. The slot/microstrip line approach requires an additional substrate where the slot and microstrip line are etched. This solution also increases cost and assembly time.

Method 4: (Hall P. S. “Probe Compensation in Thick Microstrip Patches” Electronic Letters, vol. 23, No. 11, 1987, pp 606-607). A conductive disk is attached at the end of the feed just like method 2. In this case, the disk and driven patch are located on the same layer forming an annular gap between them, thus forming a capacitor. This annular gap increases the probe capacitance required to reduce the extra probe inductance. However, the antenna radiation pattern exhibits cross-polar components (Garg et al., “Microstrip Antenna Design Handbook, ISBN 0-89006-513-6, 2001 Artech House, Inc. page 19). In addition, this arrangement results in a complex structure, especially when the patch and disk are suspended in air, thus, increasing cost.

Method 5: (Hall P. S., Dahele J. S., Haskins P. M. “Microstrip patch antennas on thick microstrip patches”, Antennas and Propagation Society International Symposium, 1989, AP-S. Digest, 1, June 1989, pp 458462). A capacitor is formed by placing a small conductive disk at the end of the feed, just like methods 2 and 4. The conductive disk is placed on top of the patch and separated from the top surface of the patch by a small gap, thus, creating the required capacitance. This extra capacitance compensates for the additional probe inductance, thus increasing the antenna bandwidth. However, this approach also results in a complex structure and high cost.

Method 6: (Luk K. M., Chow Y., Mak L., U.S. Pat. No. 6,593,887, Jul. 15, 2003). The inventors describe a patch antenna using an L-shaped feed probe. The L-shaped probe has a first portion normal to ground plane and patch, and a second portion parallel to ground plane and patch. The L-shaped probe is electromagnetically coupled to the patch. This arrangement is also effective in reducing the extra inductance of the probe. However, the total physical length of the probe is relatively large, approximately ¼ of the wavelength (i.e., 8.72 cm at 860 MHz). This large size can cause interference and EMI problems with RF circuits located in the vicinity of the probe. In addition, since the horizontal component of the L-shaped probe is much longer than the vertical section of the probe, it will be difficult to implement a two-feed circularly polarized patch antenna: the two probes may interfere with each other due to their close proximity. Another disadvantage is that the long horizontal probe requires means of mechanical support. This increases the cost and design complexity of the structure.

Thus, for the reasons mentioned above, a need exists of a simple, compact, and low-cost probe resulting in wide frequency bandwidth.

### SUMMARY OF INVENTION

According to the present invention there is provided an antenna comprising a patch which may be of pure metallic form or may be etched on a dielectric and is disposed by a dielectric a distance above a ground plane, and a helix-shaped or meandering probe disposed between said patch and said ground plane, said probe is normal to said ground plane, said antenna further comprising means for connecting said probe to means for transmitting a signal to or from said antenna, and said helical probe is adapted to be electromagnetically coupled to said patch. The patch may be rectangular, elliptical, triangular, or any other geometric shape.

In one preferred embodiment of the invention, an antenna is presented comprising a rectangular patch suspended in air above a ground plane by a distance h, and a helical probe disposed between said patch and said ground plane, said helical probe is normal to said ground plane and said patch, and spaced from one edge of the patch by a distance d, said antenna further comprising means for connecting said helix probe to means for transmitting a signal to or from said antenna. The helix may consist of several turns or a fractional turn depending of its diameter. Generally, smaller diameters result in more turns.

In another embodiment of the invention, an antenna is presented comprising a rectangular patch suspended in air above a ground plane by a distance h, and a meandering-wire probe disposed between said patch and said ground plane, said meandering-wire probe is normal to said ground plane and said patch, and spaced from the top of the patch by a distance d, said antenna further comprising means for connecting said meandering-wire probe to means for transmitting a signal to or from said antenna.

All probes according to the present invention, do not exhibit the additional inductance problem, resulting in wideband patch antenna structures. For example, the capacitance between neighboring helix turns cancels the additional inductance. For example, in the case of helix probe, the capacitance between neighboring wires neutralizes the extra inductance caused by the increase of wire length. The same effect is observed in meandering-wire structures.

The antenna may be a single antenna with one patch and one probe according to the present invention. However, viewed from another aspect, a plurality of antennas according to the present invention can form an antenna array comprising a plurality of patches disposed above a ground plane, each said patch having a respective probe disposed between said patch and said ground plane, said antenna array further comprising a transmission network connecting said probes to each other and to means for transmitting a signal to or from said antenna array. Such an antenna array may take several forms. One simple structure is an array that comprises two patches with their respective probes being connected by a single transmission line. The arrays can use one type or combination of the probes according to the present invention. Antenna arrays such as a two-by-two or four-by-four array may be formed. More complicated arrays may also be formed.

Another example is a dual band antenna structure. A preferred particular example of such structure comprises two rectangular patches and two respective probes, said both patches and probes are of different dimensions. The said patches are disposed above a ground plane and spaced at different distances from the ground plane. The dual band antenna structure further comprises a transmission line connecting said probes to each other and to means for transmitting a signal to or from said antenna structure, said transmission line being parallel to said ground plane.

It will also be understood that the patch antennas may be spaced from the ground plane by any form of dielectric material (including air) or by multiple layers of differing dielectric materials.

### BRIEF DESCRIPTION OF DRAWINGS

FIG. 1 is a diagram that illustrates a conventional patch antenna with a feed probe directly connected to the patch.

FIG. 2 is a diagram of a stacked patch antenna arrangement.

FIG. 3 is a diagram of a wideband patch antenna using a disk-loaded feed probe spaced below the patch.

FIG. 4 is a diagram of a conventional aperture-coupling patch antenna.

FIG. 5 is a diagram of a wideband patch antenna using a disk-loaded feed probe.

FIG. 6 is a diagram of a wideband patch antenna using a disk-loaded feed probe spaced above the patch.

FIG. 7 is a diagram of a wideband patch antenna using an L-shaped feed probe spaced below the patch.

FIG. 8 is a diagram of a wideband patch antenna according to the present invention, using a helix-shaped probe.

FIG. 9 is a diagram of a wideband patch antenna according to the present invention, using a meandering probe.

FIG. 10 is a diagram according to the present invention, showing two types of helical feed probes.

FIG. 11 is a diagram according to the present invention, showing two additional probe embodiments: vertical planar meandering-wire feed probes.

FIG. 12 is a diagram of a two-antenna array of wideband patch antennas according to the present invention.

FIG. 13 is a diagram of an alternative embodiment of dual-band arrangement of wideband patch antennas according to the present invention.

### DETAILED DESCRIPTION OF DRAWINGS

Illustrative embodiments and exemplary applications will now be described with reference to the accompanying drawings to disclose the advantageous teachings of the present invention.

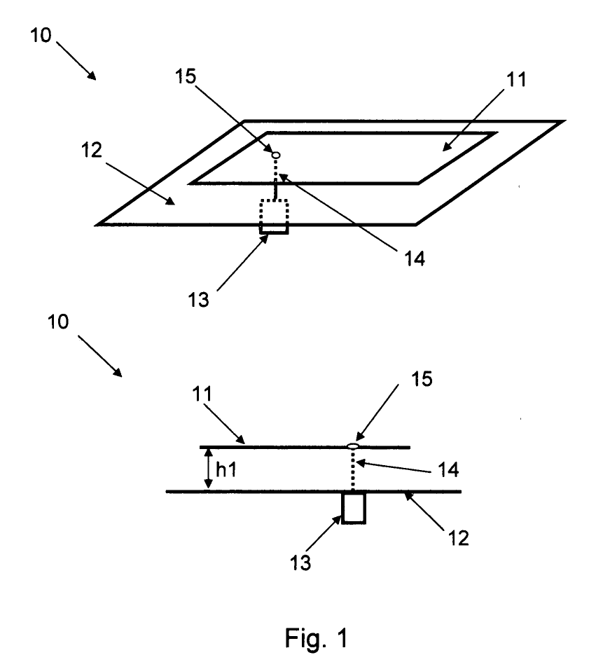

FIG. 1 shows a standard patch antenna 10, where patch 11 is suspended in air a distance h1 above ground plane 12. Patch 11 is fed by means of a coaxial connector 13, where its center conductor probe 14 is physically connected to the patch at feed point 15.

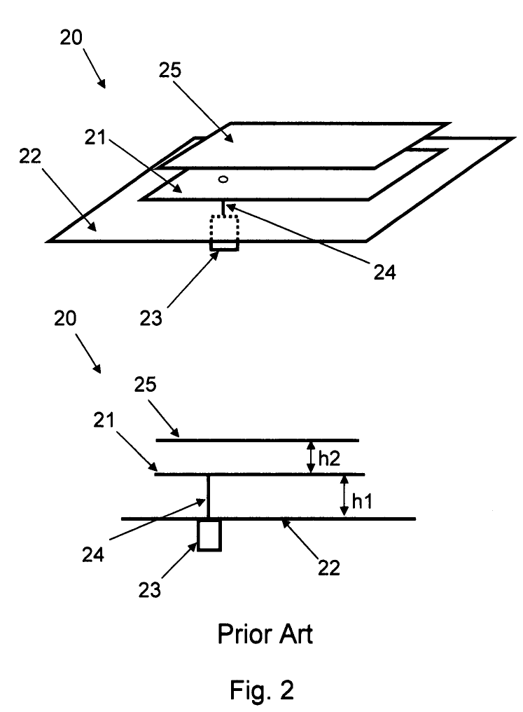

FIG. 2 illustrates method 1 described above. It shows a stacked patch antenna assembly 20. Patch 21 is suspended in air a distance h1 above ground plane 22. Patch 21 is fed by means of a coaxial connector 23, where its center conductor probe 24 is physically connected to patch 21. A second patch 25 is placed a distance h2 above patch 21.

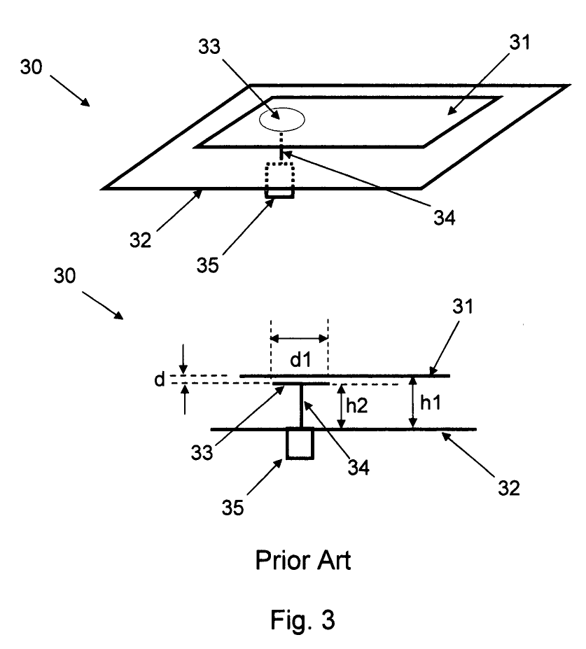

FIG. 3 illustrates method 2. It shows a wideband patch antenna assembly, 30, that utilizes a disk-loaded feed probe. Patch 31 is suspended in air a distance h1 above ground plane 32. Conductive disk 33, etched on a substrate, is attached to the top section of center conductor probe 34 of coaxial connector 35. Disk 33 has diameter d1 and is spaced at a height h2 above ground plane 32 and a small distance d below patch 31. Typical dimensions at a frequency of 1900 MHz are: patch 301: 6.5 cm×6.5 cm, h1=1 cm, d1=1 cm, d=0.08 cm.

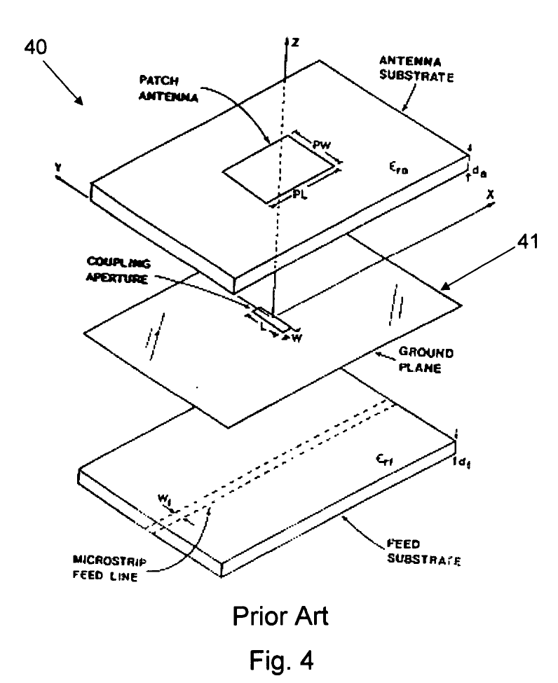

FIG. 4 shows an aperture coupling patch assembly, 40, according to method 3. The microstrip feed line is etched on the feed substrate and can be connected to a coaxial connector or cable. The coupling aperture is on ground plane 41. The patch antenna is etched on a dielectric and placed above ground plane 41.

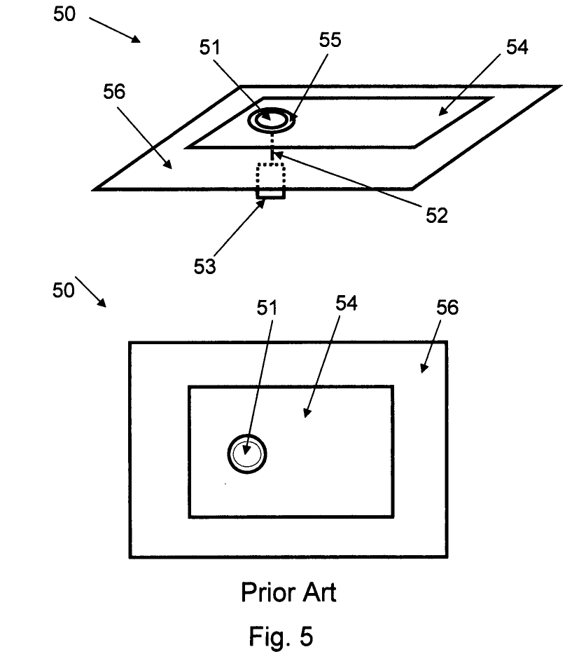

FIG. 5 shows a patch antenna assembly, 50, according to method 4. Conductive disk 51 is attached to the end of the coaxial center conductor probe 52 of coaxial connector 53. A hole in the patch allows disk 51 to be located on the same plane as patch 54 and same distance h from ground plane 56. An annular gap 55 is formed between disk 51 and patch 54.

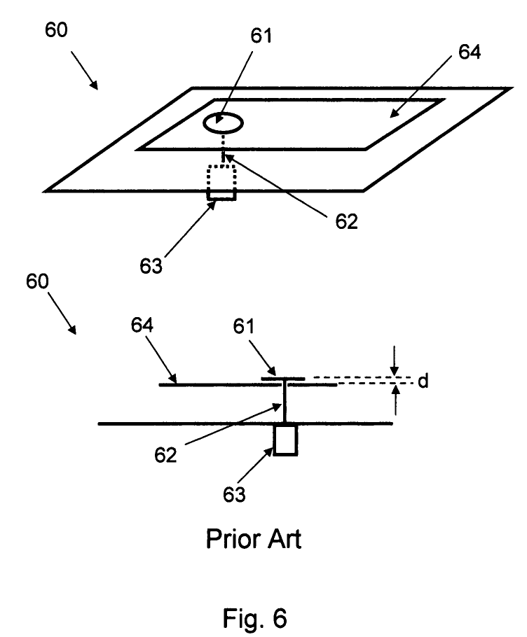

FIG. 6 illustrates a patch antenna assembly, 60, according to method 5. Conductive disk 61 is attached to the end of the coaxial center conductor probe 62 of coaxial connector 63, identical to methods 2 and 5. In this case, disk 61 is spaced above patch 64 by a distance d.

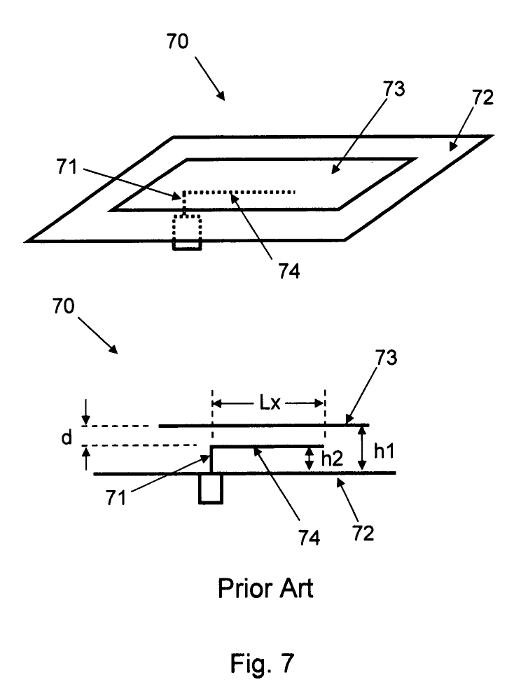

FIG. 7 shows a patch antenna assembly, 70, according to method 6. The L-shaped probe has a first portion 71 normal to ground plane 72 and patch 73, and a second portion 74 parallel to ground plane and patch. Horizontal section 74 of the probe is at a distance h2 above ground plane 72 and distance d from patch 73.

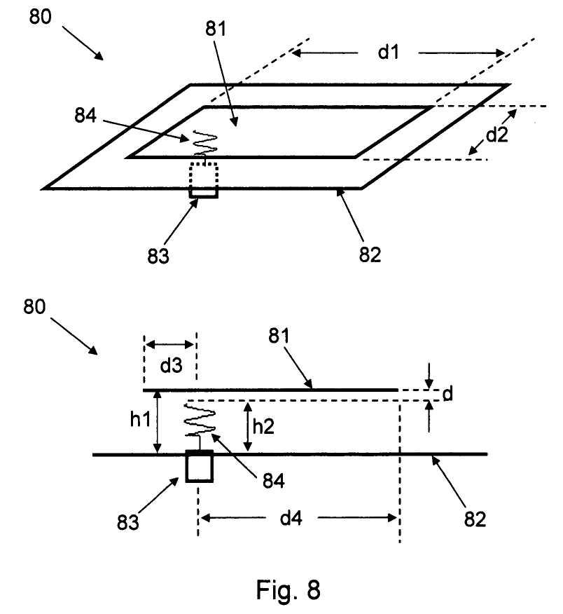

FIG. 8 is a diagram of a wideband patch antenna assembly, 80, according to the present invention. Patch 81 is suspended in air a distance h1 above ground plane 82. Patch 81 has dimensions of d1 by d2 and is fed by means of a coaxial connector 83, where its center conductor is connected to a helix 84. Helix 84 is placed underneath patch 81. The tallest point of helix 84 is at a small distance d from the bottom surface of patch 81. Helix 84 is at a distance d3 from one edge of patch 81 and d4 from the other edge of patch 81. Distance d4 is significantly larger than distance d3. Distance d3 can also be 0 mm. In some cases the helix probe does not have to be directly below patch 81 but can be placed outside the patch antenna. The height of helix 84 is h2 and it may consist of several turns or a fractional turn depending of its diameter. Typical dimensions for a patch antenna according to the present invention and operating at 1840 MHz are: ground plane=12 cm×12 cm, patch=6.7×6.7 cm, patch height=0.95 cm, helix height=0.75 cm, distance d=2 mm, helix diameter=1 cm, number of turns=1.3, wire diameter=0.5 mm. These particular dimensions result in a 12.6% bandwidth.

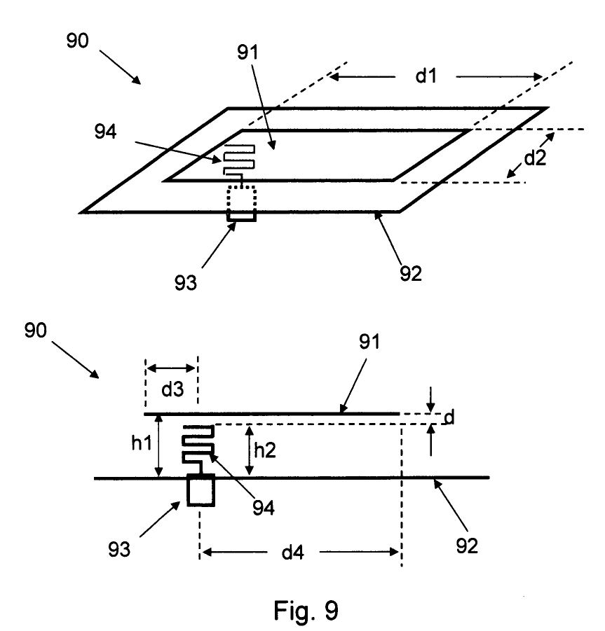

FIG. 9 is a diagram of a wideband patch antenna assembly, 90, according to the present invention, using a meandering-wire probe. Patch 91 is suspended in air a distance h1 above ground plane 92. Patch 101 has dimensions of d1 by d2 and is fed by means of a coaxial connector 93, where its center conductor is connected to the meandering wire probe 94. Probe 94 is placed underneath patch 91 at a distance d from the bottom surface of patch 91. The probe 94 is at a distance d3 from one edge of patch 91 and d4 from the other edge. Distance d4 is significantly larger than distance d3. Distance d3 can also be 0 mm. In some cases the probe 94 can be placed outside the patch antenna 91. The height of probe 94 is h2. It should be noted that meandering wire probe 94 can be realized using a substrate on which the meandering pattern is etched.

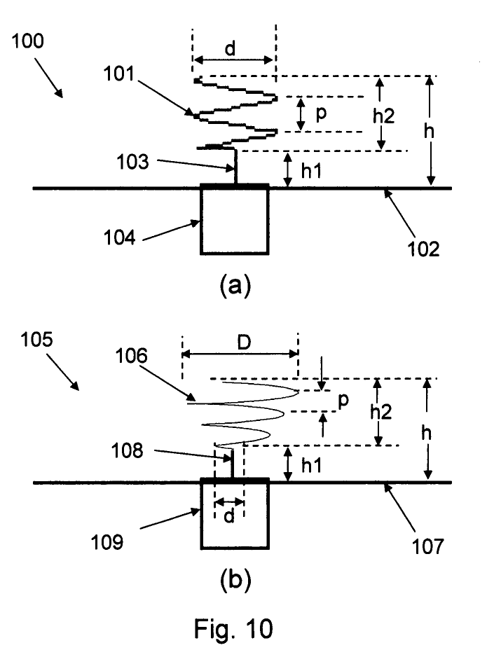

FIG. 10 (a) shows a standard helix probe 100. Helix 101 is placed above ground plane 102 and is connected to a short vertical section 103 of height h1 that is an extension of the center conductor of coaxial connector 104. The helix parameters are: diameter d, pitch p, number of turns, and height h2. The height of the total probe assembly is h.

FIG. 10 (b) shows a conical helix probe 105. Conical helix 106 is placed above ground plane 107 and is connected to a short vertical section 108 of height h1 that is an extension of the center conductor of coaxial connector 109. The helix parameters are: bottom helix diameter d, top helix diameter D, pitch p, number of turns, and height h2. The height of the total probe assembly is h.

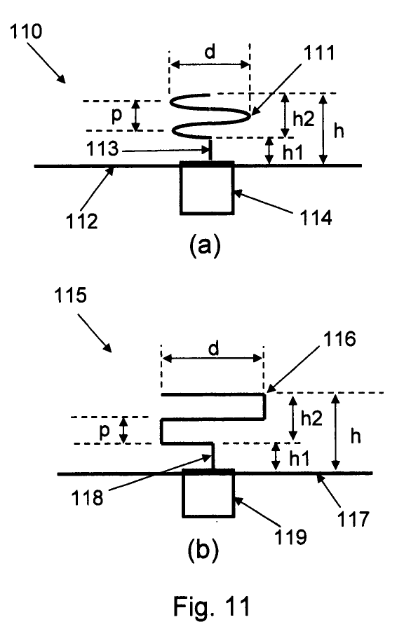

FIG. 11 (a) shows one type of vertical meandering or zigzag wire probe 110. Meandering wire section 111 is placed above ground plane 112 and is connected to a short vertical section 113 of height h1 that is an extension of the center conductor of coaxial connector 114. The meandering wire section parameters are: width d, pitch p, number of turns, and height h2. The height of the total probe assembly is h. Parameter h2 can be multiples of dimension p.

FIG. 11 (b) shows another type of vertical meandering or zigzag wire probe 115. Meandering wire section 116 is placed above ground plane 117 and is connected to a short vertical section 118 of height h1 that is an extension of the center conductor of coaxial connector 119. The meandering wire section parameters are: width d, distance between horizontal wires p, number of turns, and height h2. The height of the total probe assembly is h. Parameter h2 can be multiples of dimension p.

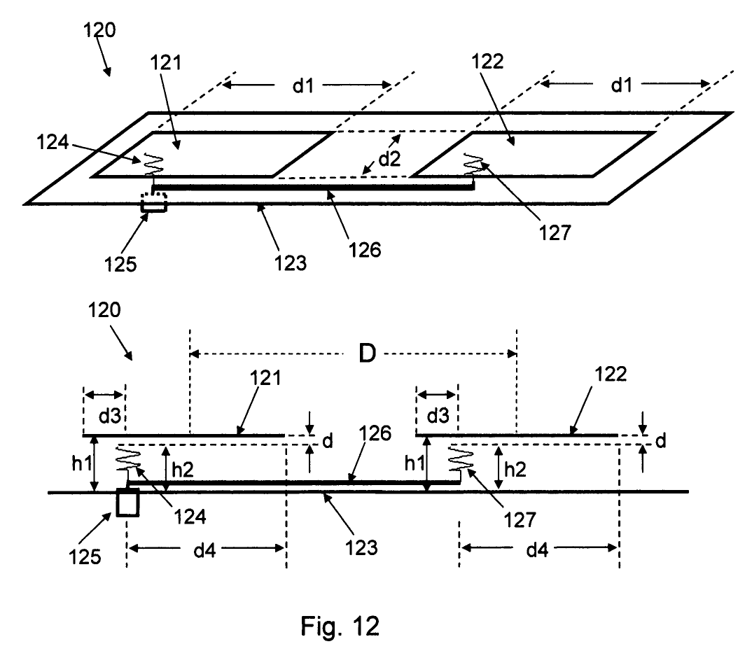

FIG. 12 is a diagram of a two-antenna array 120 of wideband patch antennas according to the present invention. Two substantially identical rectangular patches 121 and 122 each of dimensions d1 and d2 are suspended in air a distance h1 above ground plane 123. The distance between the patches is D. Helical probe 124, of height h2, is placed below patch 121 and is connected to the center conductor of connector 125 and transmission line 126. Helical probe 127 is substantially identical to probe 124 and is placed below patch 122 and is connected to transmission line 126.

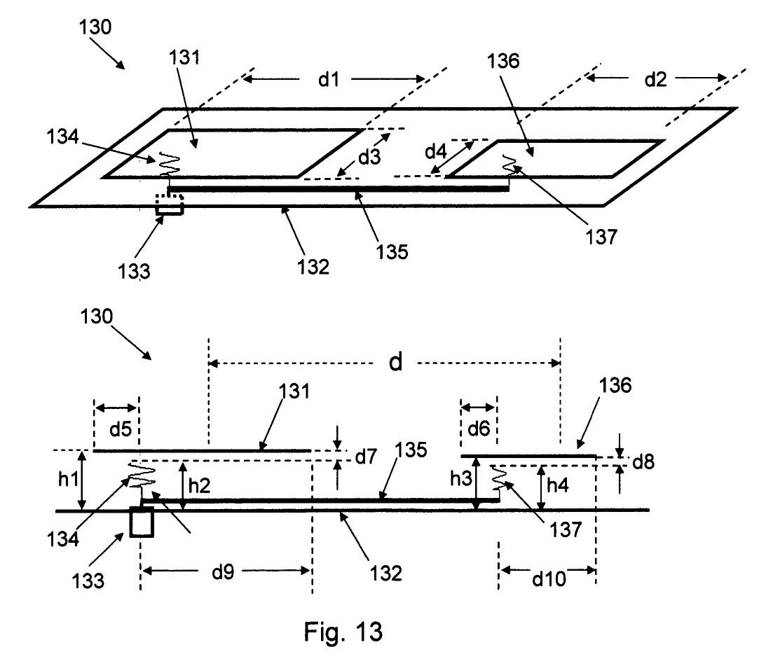

FIG. 13 is a diagram of of dual-band arrangement, 130, of wideband patch antennas according to the present invention. The assembly 130 is similar to assembly 120 of FIG. 12. One difference between assemblies 120 and 130 is that the patches and their respective probes are of different dimensions. Patch 131 of dimensions of d1 by d3 is placed a distance h1 above ground plane 132 and is fed by means of a coaxial connector 133 where its center conductor is connected to helix probe 134 of height h2, and transmission line 135. The tallest point of helix probe 134 is at a small distance d7 from the bottom surface of patch 131. Helix probe 134 is at a distance d5 from one edge of patch 131 and d9 from the other edge of patch 131. Patch 136 of dimensions of d2 by d4 is placed a distance h3 above ground plane 132 and is fed by means of transmission line 135. End of transmission line 135 is connected to helix probe 137 of height h4, located below patch 136. The tallest point of helix probe 137 is at a small distance d8 from the bottom surface of patch 136. Helix probe 137 is at a distance d6 from one edge of patch 136 and d10 from the other edge of patch 136. The distance between patches 131 and 136 is D. Patch 131 and helix probe 134 are designed to work in one frequency band, while patch 136 and probe 137 are designed to work in the other frequency band.

It should be noted that the embodiments described herein should not limit the scope of the invention. The description above is intended by way of example only and is not intended to limit the present invention in any way except as set forth in the following claims. For example, the probes according to the present invention can be connected to a transmission line or coaxial cable in addition to a coaxial connector. The meandering-shape probes can be etched on substrates like FR-4 and can be connected to the center conductor of a coaxial cable or connector, or can be connected to a microstrip transmission line. The coaxial cable shield may be soldered to the bottom side of the ground plane and the cable center conductor can connect to the probe through a hole on the ground plane. The coaxial cable shield may also be soldered to the top side of the ground plane and the cable center conductor can connect to the probe without the need for a hole on the ground plane. It shall be understood, that the patch antennas may be of pure metallic form or etched on any type of dielectric. In addition, as mentioned above, the patch antennas may be spaced from the ground plane by any form of dielectric material (including air) or by multiple layers of differing dielectric materials.

1. An antenna comprising a patch disposed above a ground plane, and a probe disposed between said patch and said ground plane, said probe having a helical shape and being substantially normal to said ground plane, said antenna further comprising means for connecting said probe to means for transmitting a signal to or from said antenna, wherein said probe is adapted to be electromagnetically coupled to said patch.

2. An antenna comprising a patch disposed above a ground plane, and a probe disposed between said patch and said ground plane, said probe having a meandering shape and being substantially normal to said ground plane, said antenna further comprising means for connecting said probe to means for transmitting a signal to or from said antenna, wherein said probe is adapted to be electromagnetically coupled to said patch.

3. The antenna as claimed in claim 2, wherein said probe is etched on a substrate and said probe being substantially normal to said patch.

4. An antenna array comprising a plurality of patches disposed above a ground plane, each said patch having a respective probe of helical shape disposed between said patch and said ground plane, each said probe is substantially normal to said ground plane, said antenna array further comprising a transmission network connecting said probes to each other and to means for transmitting a signal to or from said antenna array, wherein each said probe is adapted to be electromagnetically coupled to each said respective patch.

5. The antenna array as claimed in claim 4, wherein each said probe having a meandering shape.

6. The antenna array as claimed in claim 4, wherein each said probe is etched on a substrate and having a meandering shape, each said meandering shape probe being substantially normal to said patch.

7. The antenna array as claimed in claim 4, wherein at least one said probe having a helical shape and at least one said probe having a meandering shape.

8. A dual band antenna comprising two patches of different size and disposed a different distance above a ground plane, each said patch having a respective probe of helical shape disposed between each said patch and said ground plane, each said probe is substantially normal to said ground plane, said dual band antenna further comprising a transmission network connecting said probes to each other and to means for transmitting a signal to or from said dual band antenna, wherein each said probe is adapted to be electromagnetically coupled to each said respective patch.

9. The dual band antenna as claimed in claim 8, wherein each said probe having a meandering shape.

10. The dual band antenna as claimed in claim 8, wherein each said probe is etched on a substrate and having a meandering shape, each said meandering shape probe being substantially normal to each said respective patch.

11. The dual band antenna as claimed in claim 8, wherein one said probe having a helical shape and the other said probe having a meandering shape.
